(19) United States
(12) Patent Application Publication
(10) Pub. No.: US 2002/0071590 A1
(43) Pub. Date: Jun. 13, 2002

(54) Magnetic circuit of micro speaker

(75) Inventors: Man-Dae Han, Kyungki-do (KR); Bok-Beum Kim, Kyungki-do (KR)

Correspondence Address: Don W. Bulson, Esq., Renner, Otto, Boisselle & Sklar, P.L.L., 19th Floor, 1621 Euclid Ave., Cleveland, OH, 44115, US

(73) Assignee: SAMSUNG ELECTRO-MECHANICS CO., LTD.

(21) Appl. No.: 09/885,351

(22) Filed: Jun. 20, 2001

(30) Foreign Application Priority Data
Dec. 9, 2000 (KR) 2000-74895

(51) Int. Cl. H04R 1/00

(52) U.S. Cl. 381/412; 381/420

(57) ABSTRACT

A magnetic circuit of a micro speaker is disclosed. A magnet and an upper plate are mounted upon a yoke part, and this structure is placed within upper and lower dies, leaving a gap. Then an injection molding is carried out by injecting a resin into the gap within the dies, so that a speaker frame is formed to unitizingly secure the yoke part, the magnet and the upper plate, thereby completing the magnetic circuit of the micro speaker. Thus the coupling between the components are made firm, and the product can be made slim.

### FIELD OF THE INVENTION

The present invention relates to a magnetic circuit of a micro speaker. Particularly, the present invention relates to a magnetic circuit of a micro speaker, in which a yoke part, a magnet placed upon the yoke part, and an upper plate placed upon the magnet are coupled by a speaker frame without requiring a separate coupling of the element components. So that the coupling of the components of the magnetic circuit of the micro speaker would be easy, and that the product can become slim.

### BACKGROUND OF THE INVENTION

The generally known micro speaker includes: a magnetic circuit part consisting of a yoke part with a magnet secured thereon, and upper and lower plates; an oscillating part consisting of a bobbin with voice coil wound thereon and inserted into the magnet, an oscillating plate and a damper joined to the outside of the bobbin, a dust cap for preventing any contaminating materials from intruding into the bobbin, and an edge for connecting the oscillating plate to the frame; and a main body consisting of a frame for protecting the magnetic circuit part and the oscillating part, and a gasket for securing the oscillating plate to the frame, whereby electrical signals are converted into voices by the voice coil to be outputted to the outside.

As shown in FIG. 1, the magnetic circuit of the conventional micro speaker is constituted as described below.

That is, the magnetic circuit includes: a yoke part 10 of the speaker; a magnet 30 and an upper plate 40. In these components, the magnet 30 and the upper plate 40 are stacked sequentially within the yoke part 10 by using an adhesive 50, with a gap 20 being left between the stacked members 30 and 40 and the wall of the yoke part 10.

In the magnetic circuit constituted as described above, the magnet 30 is fixed by using the adhesive 50 in such a manner that the gap 20 can be maintained, thereby completing the attachment of the magnet 30.

Then thereupon, the adhesive 50 is spread again, and the upper plate 40 is mounted upon it, and then, the upper plate 40 is pressed down while drying the adhesive 50, thereby finally completing a magnetic circuit 60 of the micro speaker.

However, in the above speaker magnetic circuit, in order to fix the magnet 30 and the upper plate 40 while maintaining the gap 20, the adhesive 50 is spread on the magnet 30, and the magnet 30 is pressed down, so that the magnet 30 can be fixed by the curing of the adhesive 50.

Further, the upper plate 40 is placed upon the magnet 30 after spreading the adhesive 50, and the upper plate 40 is pressed down, so that the magnet 30 and the upper plate 40 would be fixed within the yoke part 10. Accordingly, the number of the process steps is increased, while the workability and the productivity are also aggravated.

Further, the spreading of the adhesive 50 for securing the magnet 30 and the upper plate 40 can scarcely realize a uniformity, with the result that non-attaching portions occur. Therefore, it is very liable that the magnet 30 and the upper plate 40 will be gaping apart after the fixing. Thus the magnet 30 and the upper plate 40 cannot be firmly attached. Further, if the spread amount of the adhesive 50 is excessive, then the adhesive will flow down into gap 20 of the yoke part 10, and this will cause an interference to the oscillations of the bobbin, thereby producing defective products.

### SUMMARY OF THE INVENTION

The present invention is intended to overcome the above described disadvantages of the conventional technique.

Therefore it is an object of the present invention to provide a magnetic circuit of a micro speaker, in which a yoke part, a magnet placed upon the yoke part, and an upper plate placed upon the magnet are coupled to a speaker frame without requiring a separate coupling of the element components by means of an adhesive. So that the coupling of the components of the magnetic circuit of the micro speaker would be easy, that the product would be slim, and that the fixing of the magnetic circuit would be very firm.

In achieving the above object, the magnetic circuit of a micro speaker according to the present invention includes: a yoke part having a stepped part projecting at a center thereof and having a securing part formed around a bottom circumference of the yoke part; a magnet mounted upon the yoke part to form the magnetic circuit; an upper plate mounted upon the magnet and having a close contact part around an upper circumference of the upper plate; and a speaker frame formed by using a coupling means and for unitizingly securing the yoke part, the magnet and the upper plate.

### BRIEF DESCRIPTION OF THE DRAWINGS

The above object and other advantages of the present invention will become more apparent by describing in detail the preferred embodiments of the present invention with reference to the attached drawings, in which:

FIG. 1 illustrates a coupled state of the magnetic circuit components of the general speaker;

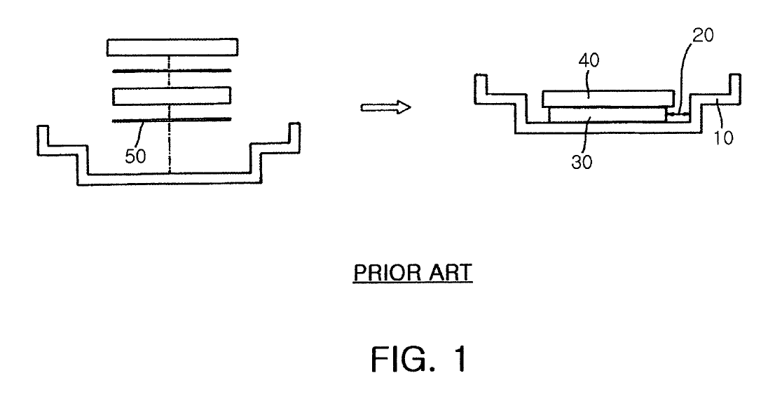

FIG. 2 illustrates a fixed state of the magnetic circuit of the speaker according to the present invention;

FIG. 3 illustrates a coupled state of the speaker magnetic circuit according to the present invention;

FIG. 4 is an exploded perspective view of the speaker magnetic circuit according to the present invention;

FIG. 5 is a perspective view showing the coupled state of the speaker magnetic circuit of FIG. 4;

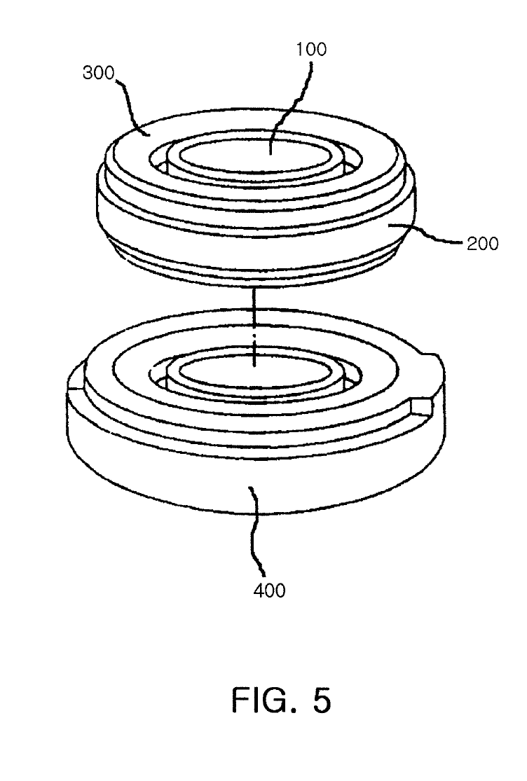

FIG. 6 illustrates the injection molding method for the speaker magnetic circuit according to the present invention;

FIG. 7 illustrates the coupled state of the speaker magnetic circuit in a second embodiment of the present invention;

FIG. 8 is an exploded view of the speaker magnetic circuit in the third embodiment of the present invention; and

FIG. 9 is a sectional view showing the coupled state of the speaker magnetic circuit of FIG. 8.

### DESCRIPTION OF THE PREFERRED EMBODIMENTS

The present invention will be described in detail referring to the attached drawings.

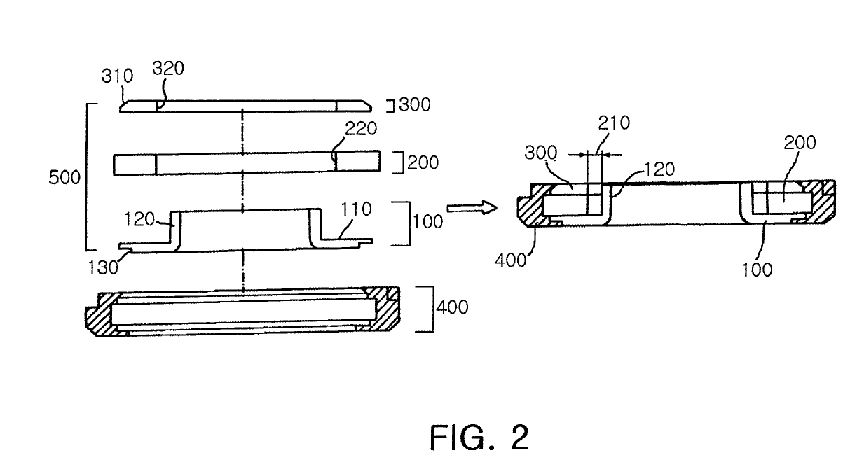

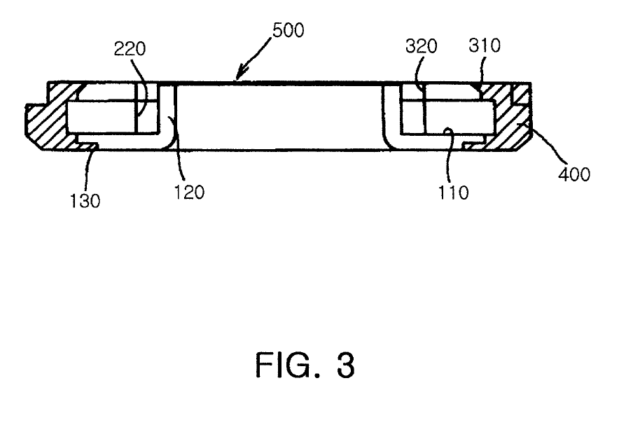

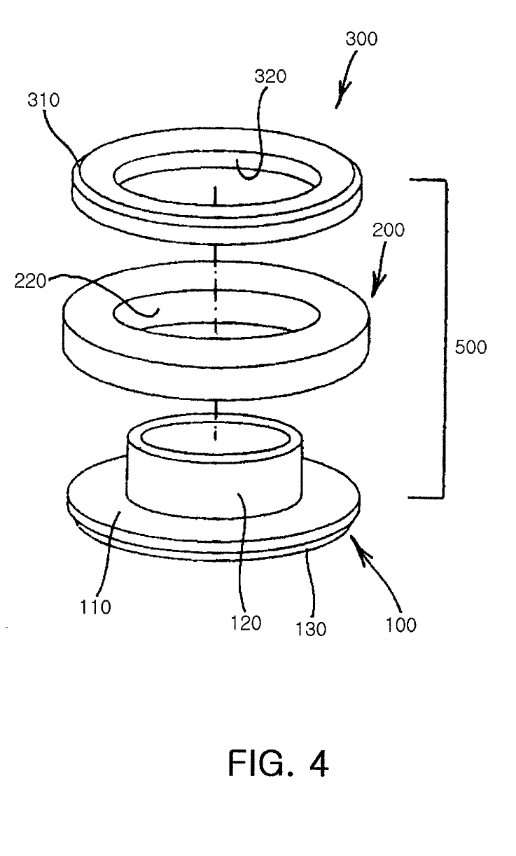

FIG. 2 illustrates a fixed state of the magnetic circuit of the speaker according to the present invention. FIG. 3 illustrates a coupled state of the speaker magnetic circuit according to the present invention. FIG. 4 is an exploded perspective view of the speaker magnetic circuit according to the present invention.

The magnetic circuit 500 of the micro speaker according to the present invention includes: a yoke part 100, a magnet 200, an upper plate 300 and a speaker frame 400.

The yoke part 100 includes: a flat part 110, a stepped part 120 integrally upstanding from the center of the flat part 110, and a securing part 130 formed on the bottom circumference of the flat part 110. This yoke part 100 is coupled to the speaker frame 400.

Here, the upper portion of the stepped part 120 which project upward at the center of the yoke part 100 is open or closed. Around the bottom circumference of the yoke part 100, there is formed the securing part 130 which is also of a stepped form.

The magnet 200 is stacked upon the flat part 110 of the yoke part 100 so as to form the magnetic circuit. Further, the magnet 200 has a through hole 220 through which the stepped part 120 of the yoke part 100 is inserted. Under this condition, the through hole 220 of the magnet 200 has a diameter larger than the outside diameter of the stepped part 120, so that a gap 210 is formed between the stepped part 120 and the magnet 200.

The upper plate 300 which is stacked upon the magnet 200 has a through hole 320 through which the stepped part 120 of the yoke part 100 is inserted. Under this condition, the through hole 320 of the upper plate 300 has a diameter larger than the outside diameter of the stepped part 120, so that the gap 210 is formed between the stepped part 120 and the upper plate 300.

As shown in FIG. 4, the through hole 320 of the upper plate 300 has a size same as the through hole 220 of the magnet 200. Around the outer circumference of the upper plate 300, there is formed a close contact part 310. This close contact part 310 acts to prevent the stacked structure from being detached from the speaker frame 400 which will be described later.

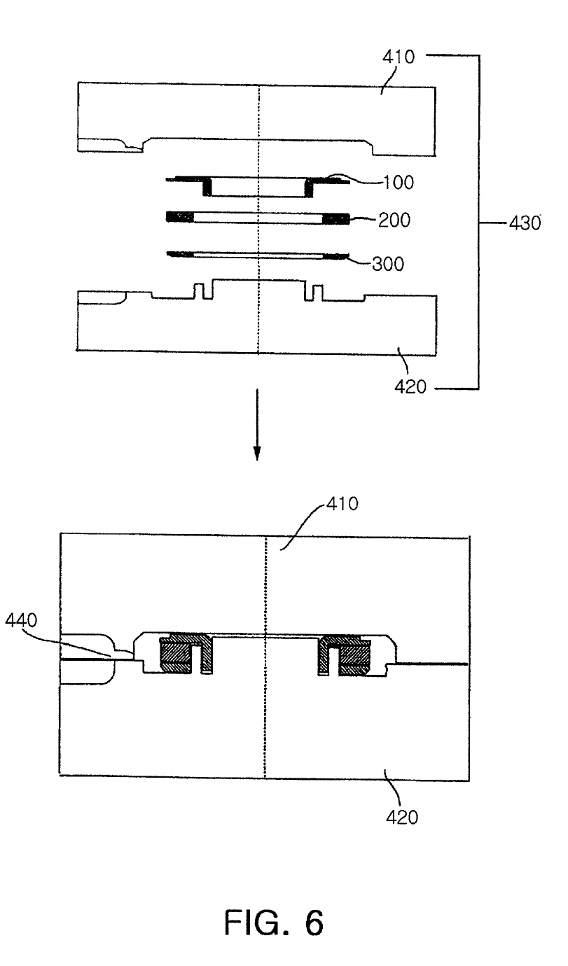

The speaker frame 400 secures the yoke part 100, the magnet 200 and the upper plate 300 into a unitized form. As shown in FIG. 6, the speaker frame 400 is fabricated by an insert injection molding by using a coupling means 430 which consists of upper and lower dies 410 and 420.

Under this condition, the yoke part 100 having the stepped securing part 130 around its circumference, the magnet 200 and the upper plate 300 having the inclined close contact part 310 are disposed between the upper and lower dies 410 and 420. Then an insert injection molding is carried out to form the speaker frame 400 so as to unitizingly secure the three elements 100, 200 and 300.

That is, the speaker frame 400 is formed by an injection molding to unitizingly pack the yoke part 100, the magnet 200 and the upper plate 300. This will be described in detail below.

That is, the yoke part 100, the magnet 200 and the upper plate 300 are placed within the lower die 420 without using any fixing means, and under this condition, there is formed a space between the lower die 420 and the three elements 100, 200 and 300.

When the yoke part 100, the magnet 200 and the upper plate 300 have been placed within the lower die 420, the upper die 410 is fitted to the lower die 420. Then a resin is injected through an injection hole 440 which is formed between the upper and lower dies 410 and 420.

Thus the speaker frame 400 is formed by an injection molding by using the upper and lower dies 410 and 420, so as to form the speaker magnetic circuit 500 which includes the yoke part 100, the magnet 200 and the upper plate 300.

Meanwhile, the assembly of the yoke part 100, the magnet 200 and the upper plate 300, which has been secured by the speaker frame 400 through the injection molding cannot be detached from the speaker frame 400 owing to the stepped securing part 130 of the yoke part 100 and the inclined close contact part 310 of the upper plate 300. Thus the three elements 100, 200 and 300 are firmly supported by the speaker frame 400.

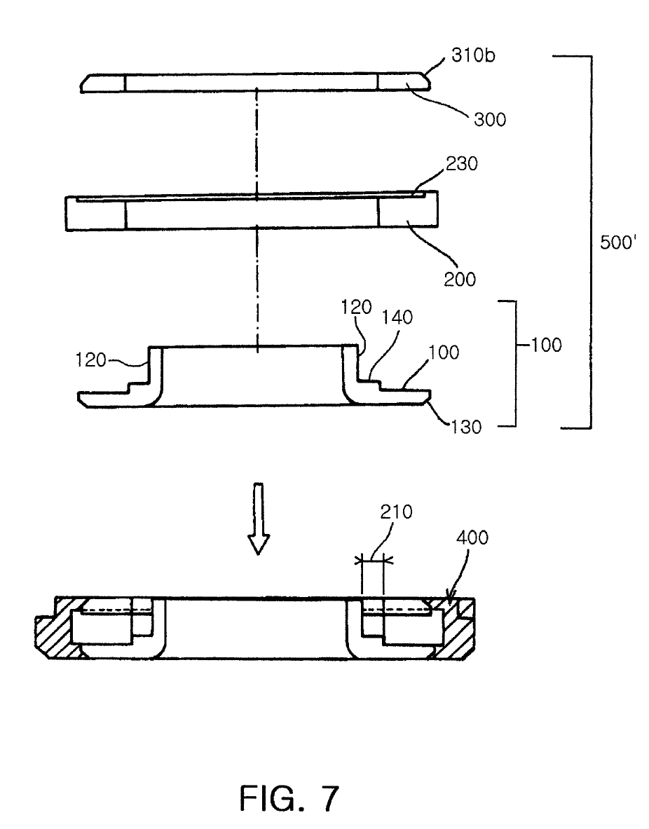

FIG. 7 illustrates the coupled state of the speaker magnetic circuit in a second embodiment of the present invention.

In this second embodiment as shown in this drawing, the magnetic circuit 500′ of the micro speaker includes: a yoke part 100, a magnet 200, an upper plate 300 and a speaker frame 400. Here, the yoke part 100 includes: a flat part 110 and a stepped part 120, the latter integrally upstanding on the flat part 110. Further, a magnet securing projection part 140 is formed between the flat part 110 and the stepped part 120.

Further, an inversely inclined securing part 130 is formed around the bottom circumference of the yoke part 100, so as to be coupled to the speaker frame 400 which will be described later.

Under this condition, the upper portion of the stepped part 120 which projects up from the center of the yoke part 100 is open or closed. The securing part 130 is formed around the bottom circumference of the yoke part 100, so that the yoke part 100 is supported by the speaker frame 400.

The magnet securing projection part 140 which is formed between the flat part 110 and the stepped part 120 has a diameter same as the diameter of the through hole 220 of the magnet 200.

Thus, if the magnet 200 is fitted to the stepped part 120 of the yoke part 100, the magnet securing projection part 140 is closely fitted to the through hole 220 of the magnet 200. Thus any loose movements of the magnet 200 is prevented, while a gap 210 is formed between the magnet 200 and the stepped part 120 of the yoke part 100.

That is, the magnet 200 is stacked upon the flat part 110 of the yoke part 100 so as to form an element member of the magnetic circuit. The magnet 200 has the through hole 220, and the through hole 220 of the magnet 200 has a diameter larger then the outside diameter of the stepped part 120, so that the gap 210 is formed between the stepped part 120 of the yoke part 100 and the magnet 200.

Under this condition, within the circumference of the through hole 220 of the magnet 200, there is formed a plate securing part 230 which is a recess, so that the bottom of the upper plate 300 is placed within the plate securing part 230.

The upper plate 300 which is disposed upon the magnet 200 has a through hole 320 so as to be fitted to the stepped part 120 of the yoke part 100. Under this condition, the through hole 320 of the upper plate 300 has a diameter larger than the diameter of the stepped part 120 of the yoke part 100, so that the gap 210 is formed between the through hole 320 of the upper plate 300 and the stepped part 120 of the yoke part 100.

As shown in FIG. 7, the through hole 320 of the upper plate 300 has a size same as that of the through hole 220 of the magnet 200. Further, the inclined close contact part 310 is formed around the upper circumference of the upper plate 300, and therefore, the upper plate 300 cannot be detached from the speaker frame 400 which will be described later.

Further as shown in FIG. 7, the bottom of the upper plate 300 is fitted into the plate securing part 230 which is a recess formed on the top of the magnet 200. Thus the upper plate 300 is securely supported on the top of the magnet 200.

Thus the speaker frame 400 packs the yoke part 100, the magnet 200 and the upper plate 300 into a unitized structure. This speaker frame 400 can be formed by an insert injection molding in a simple manner without causing any loose movements of the components by using a coupling means 430 which consists of upper and lower dies 410 and 420 like in the first embodiment.

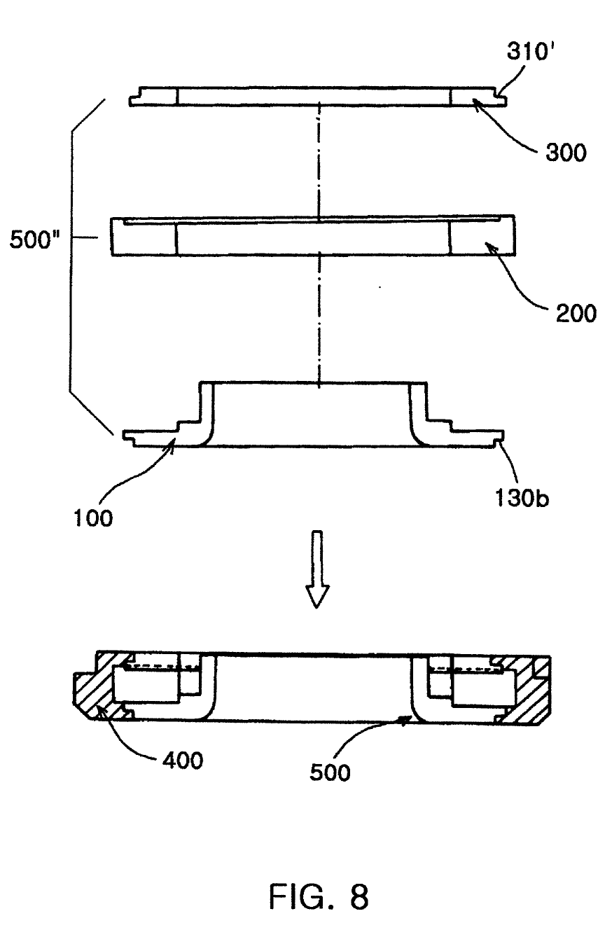

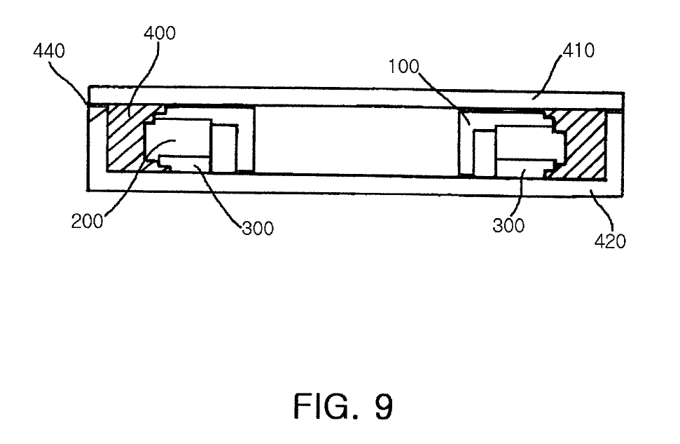

FIG. 8 is an exploded view of the speaker magnetic circuit in the third embodiment of the present invention. FIG. 9 is a sectional view showing the coupled state of the speaker magnetic circuit of FIG. 8.

Like in the second embodiment of the present invention, the magnetic circuit 500″ of the micro speaker of this third embodiment includes: a yoke part 100, a magnet 200, an upper plate 300 and a speaker frame 400. The yoke part 100, the magnet 200 and the upper plate 300 have exactly same structures as those of the second embodiment except the feature described below. As shown in FIG. 8, the upper plate 300 has a stepped close contact part 310′, and therefore, the upper plate 300 cannot be detached from the speaker frame 400, but is firmly supported by the speaker frame 400.

According to the present invention as described above, a yoke part, a magnet placed upon the yoke part, and an upper plate placed upon the magnet are coupled to a speaker frame without requiring a separate coupling of the element components by means of an adhesive. So that the coupling of the components of the magnetic circuit of the micro speaker would be easy, that the product would be slim, and that the fixing of the magnetic circuit would be very firm.

What is claimed is:

1. A magnetic circuit of a micro speaker, comprising:
a yoke part having a stepped part projecting at a center thereof and having a securing part formed around a bottom circumference of the yoke part;
a magnet mounted upon the yoke part to form the magnetic circuit;
an upper plate mounted upon the magnet and having a close contact part around an upper circumference of the upper plate; and
a speaker frame formed by using a coupling means and for unitizingly securing the yoke part, the magnet and the upper plate.

2. The magnetic circuit as claimed in claim 1, wherein the stepped part of the yoke part has an open upper portion.

3. The magnetic circuit as claimed in claim 1, wherein the stepped part of the yoke part has a closed upper portion.

4. The magnetic circuit as claimed in claim 1, wherein the yoke part has a stepped securing part on its bottom circumference.

5. The magnetic circuit as claimed in claim 1, wherein the magnet and the upper plate mounted upon a flat part of the yoke part as constituents of the magnetic circuit have respectively a through hole so as to receive the stepped part of the yoke part.

6. The magnetic circuit as claimed in claim 5, wherein the through holes of the magnet and the upper plate respectively have an inside diameter larger than an outside diameter of the stepped part of the yoke part.

7. The magnetic circuit as claimed in claim 5, wherein the through holes of the magnet and the upper plate are of a same size.

8. The magnetic circuit as claimed in claim 1, wherein the close contact part formed around a circumference of the upper plate is inclined so as to prevent the upper plate from being detached from the speaker frame.

9. The magnetic circuit as claimed in claim 1, wherein the coupling means for enabling the speaker frame to secure the yoke part, the magnet and the upper plate consists of upper and lower dies forming a certain gap within them; and the gap is formed into the speaker frame by an insert injection molding.

10. A magnetic circuit of a micro speaker, comprising:
a yoke part having a stepped part projecting at a center thereof, having a securing part formed around a bottom circumference of the yoke part, and having a magnet securing projection part formed between the stepped part and a flat part of the yoke part;
a magnet mounted upon the yoke part, having a through hole for receiving the stepped part of the yoke part, and a plate securing part which is a recess for settling a bottom of an upper plate;
the upper plate being mounted upon the magnet and having a close contact part around an upper circumference of the upper plate; and
a speaker frame formed by using a coupling means and for unitizingly securing the yoke part, the magnet and the upper plate.

11. The magnetic circuit as claimed in claim 10, wherein the magnet securing projection part formed between the flat part and the stepped part of the yoke part has an outside diameter same as the diameter of the through hole of the magnet so as to make the magnet securing projection part closely fitted to the through hole of the magnet.

12. The magnetic circuit as claimed in claim 10, wherein the through holes of the magnet and the upper plate respectively have a diameter larger than an outside diameter of the stepped part so as to leave a gap between the stepped part of the yoke part and the magnet and the upper plate.

13. The magnetic circuit as claimed in claim 10, wherein the through holes of the magnet and the upper plate are same in their sizes.

14. The magnetic circuit as claimed in claim 10, wherein the coupling means for enabling the speaker frame to unitizingly secure the yoke part, the magnet and the upper plate consists of upper and lower dies; and a certain gap is left within the upper and lower dies so as to form the speaker frame by an insert injection molding.
